(19) United States
(12) Patent Application Publication
(10) Pub. No.: US 2014/0122194 A1
(43) Pub. Date: May 1, 2014

(54) Cross-Platform Targeting

(71) Applicant: YAHOO! INC., Sunnyvale, CA (US)

(72) Inventor: Gaurav Kamdar, Bangalore (IN)

(73) Assignee: YAHOO! INC., SUNNYVALE, CA (US)

(21) Appl. No.: 13/666,466

(22) Filed: Nov. 1, 2012

(51) Int. Cl. G06Q 30/02

(52) U.S. Cl. 705/14.5

(57) ABSTRACT

A system and method for cross-platform targeting includes: receiving as input calendar entries from an on-line calendar associated with a first user, the calendar entries designating specified time slots associated with scheduled events; marking the specified time slots associated with the scheduled events as unavailable time slots; eliminating the unavailable time slots from the calendar associated with the first user; determining from remaining time slots those time slots wherein the first user is deemed unlikely to be available; removing those time slots from the calendar, providing free time slots; and presenting the free time slots as optimal time slots for serving digital information to the first user.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of on-line ad targeting, and more particularly relates to the field of on-line ad targeting using available time slots.

### BACKGROUND OF THE INVENTION

On-line calendar sharing is widely used to schedule meetings. Some advertisers favor using calendar sharing to target advertisements (ads). The advertisers take note of the event context from the shared calendars in order to target ads based on the context. Facebook Events and the like are also used to target ads but that is only within the Facebook user networks and only pertaining to the event. These types of targeting are context-driven.

Another avenue available for advertisers is a feature on some sites where the user is explicitly asked when he/she is available to received ads/offers/promotions. Some of these sites are direct, asking “When is a good time to reach you?”

While these methods offer some advantages, they all require too much overhead. In the case of the sites such as Facebook Events and calendar sharing, since the ad targeting is context-driven, the processing is burdensome because just knowing that an event occurs is not enough—the context must be retrieved, parsed, and analyzed. This creates a privacy issue as well. In the case of the direct enquiry, user cooperation and interaction is necessary.

There is a need for a system and method that overcomes the above-stated shortcomings of the known art.

### SUMMARY OF THE INVENTION

Briefly, according to an embodiment of the invention a method for cross-platform targeting includes steps or acts of: receiving as input calendar entries from an on-line calendar associated with a first user, the calendar entries designating specified time slots associated with scheduled events; marking the specified time slots associated with the scheduled events as unavailable time slots; eliminating the unavailable time slots from the calendar associated with the first user; determining from remaining time slots those time slots wherein the first user is deemed unlikely to be available; removing those time slots from the calendar, thus providing free time slots; and presenting the free time slots as optimal time slots for serving digital information to the first user.

According to another embodiment of the present invention, a system for cross-platform targeting includes a processor device and a memory with computer-executable instructions stored therein. The computer-executable instructions include: receiving as input calendar entries from an on-line calendar associated with a first user, the calendar entries designating specified time slots associated with scheduled events; marking the specified time slots associated with the scheduled events as unavailable time slots; eliminating the unavailable time slots from the calendar associated with the first user; determining from remaining time slots those time slots wherein the first user is deemed unlikely to be available; removing those time slots from the calendar, thus providing free time slots; and presenting the free time slots as optimal time slots for serving digital information to the first user.

According to another embodiment of the present invention, a computer program product includes a tangible computer-readable storage medium with computer-executable stored therein. The computer-executable instructions include: receiving as input calendar entries from an on-line calendar associated with a first user, the calendar entries designating specified time slots associated with scheduled events; marking the specified time slots associated with the scheduled events as unavailable time slots; eliminating the unavailable time slots from the calendar associated with the first user; determining from remaining time slots those time slots wherein the first user is deemed unlikely to be available; removing those time slots from the calendar, thus providing free time slots; and presenting the free time slots as optimal time slots for serving digital information to the first user.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a flowchart of a method according to an embodiment of the present invention;

FIG. 2 is an exemplary screenshot of a calendar event, according to the known art;

FIG. 3 is a lower-level flowchart of a method according to an embodiment of the present invention;

FIG. 4 is a simplified block diagram of a system on which embodiments of the present invention can be implemented; and

FIG. 5 is a high level block diagram showing a hardware device configured to operate according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a system and method for cross-platform targeting based on the user's ability to consume data in real-time, as inferred by our targeting system. We provide a new parameter for efficient ad/content targeting. Using this new parameter, serving data such as ads becomes more effective and has a higher probability to provide positive monetization results by involving third party mail and calendar clients in an inferred way.

Calendars used for on-line scheduling include, for each day, multiple time slots. Each of the time slots, singly or in combination, can be designated as FREE (the default) or BUSY when an event is scheduled. When an event is scheduled, such as a meeting, the time slots corresponding to the meeting times are marked as BUSY in a manner according to the proprietary calendar system. Additionally, the time slots marked as BUSY can also provide information about the meeting and/or the participants. For example, the location of the meeting, the agenda, and who has accepted or declined the meeting invitation can be shown in the calendar. As previously stated, known methods of targeting use the meeting information to target ads based on the such things as the meeting topic.

The method according to the invention does not need to read the contextual information for the meeting; instead we use the time slot designations (FREE or BUSY) to learn when to target an ad. We do this implicitly in an intelligent and automated manner. We use the available FREE slots in a calendar as a guide for when to direct ads for a better viewing hit rate. In this way we avoid domain restrictions; therefore we span across platforms. By not reading the context of the scheduled events, we restore the user's privacy, which can be seriously compromised with current methods.

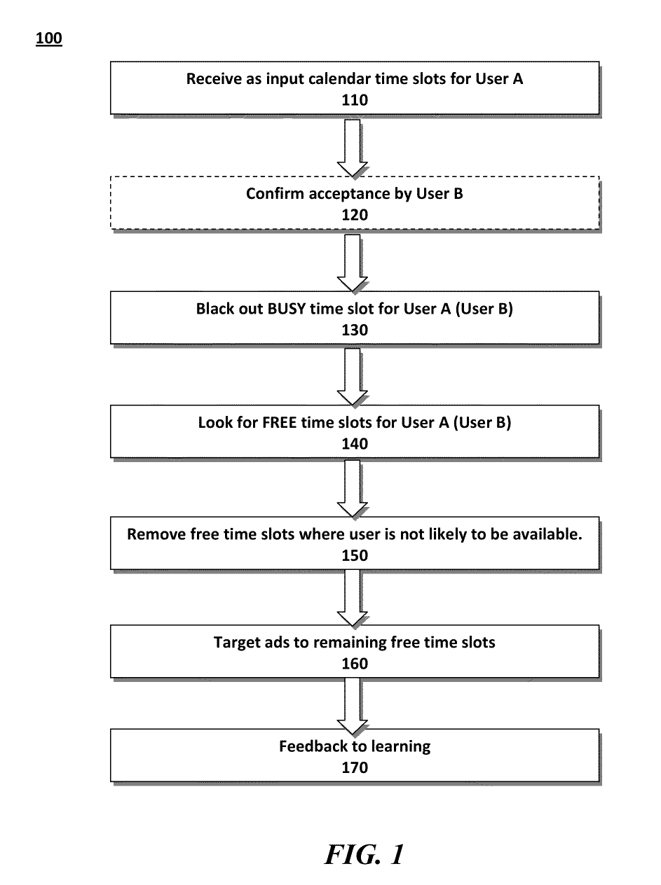

The present invention will now be described with respect to FIGS. 1 through 5 which are block diagrams and flowchart illustrations of embodiments of the present invention. It will be understood that each block of the flowchart illustrations and/or block diagrams, and combinations of blocks in the flowchart illustrations and/or block diagrams, can be implemented by computer program instructions.

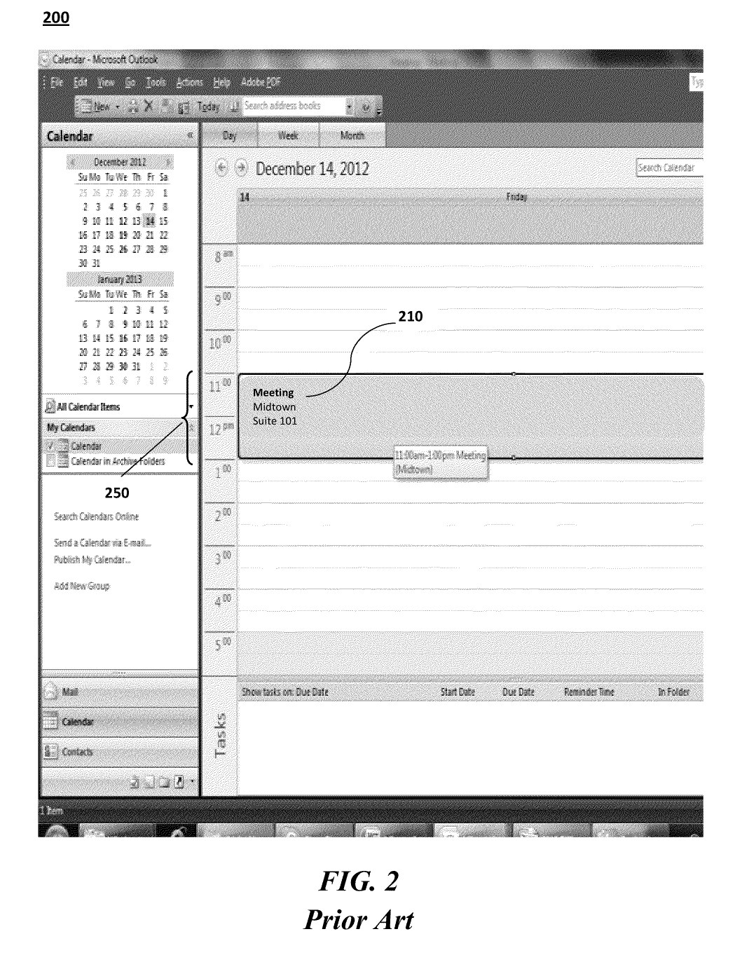

Referring now in detail to the drawings and to FIG. 1 in particular, there is shown a flow chart 100 of a method for cross-platform targeting, according to an embodiment of the present invention. In step 110 we receive as input calendar entries and/or a calendar for User A. We show one simplified example of a portion of an Outlook calendar 200 showing one entry 210 in FIG. 2. This particular example is provided to show one possible use of the targeting method. One with knowledge in the art will appreciate that this method is both platform and device agnostic. Calendars in Google Calendar, Yahoo! Calendar and Dayviewer, to name a few, can be utilized according to embodiments of the invention.

In FIG. 2 we see that User A has booked an event 210 for Friday, Dec. 14, 2012. The event 210 is a meeting that begins at 11:00 a.m. and ends at 1:00 p.m. Returning to FIG. 1 we can perform the optional step 120 of confirming that the other participant(s) in the event 210 has/have accepted, indicating that User B will also be busy at that time.

Whether or not we perform this optional step 120, in the next step 130 we black out the time slot 250 where we know that User A is BUSY. Optionally we can also black out the same time slot 250 for User B. We use the familiar term “black out” to mean that we store and allocate that time slot as Busy/Not Available. We assume that the meeting 210 will not involve browsing emails or web pages. This means that there is a ‘high probability’ that both users are ‘Busy’ at this time and may not be able to give 100% attention to content being sent to them or their web pages where personalization is possible. This is therefore a good time to hold off on sending communication such as an ad or content which will likely not be viewed. Any communication slated for User A will be held until the next available FREE time slot.

Now that we know which times slots to avoid for User A (and potentially User B), in step 140 we allocate the remaining time slots to possible “free time.” In step 150 we eliminate those allocated time slots where it can be assumed that User A (and perhaps User B) is/are not available, such as the middle of the night. These “dead zone” time slots are initially inferred by common practice knowledge and logical assumptions. For example, we may initially set default “dead zone” time slots for User A for weekdays between midnight and seven o'clock a.m.; and all of Saturday and Sunday.

This default setting can be overridden when, after a while we take note that User A has scheduled occasional Saturday morning events 210. From this data we can infer that User A works on Saturday mornings; therefore, we open up Saturday mornings for User by eliminating them from User A's “dead zone” time slots, and allocating them as possible free time. Going forward, only those Saturday morning time slots 210 where User A has a meeting scheduled will be off limits for ad targeting. This is one example of how the method provides its own feedback for learning and refining the optimal times to serve/push data.

Now that we have stored “free time” time slots 210 for User A (and possibly User B) in step 160 we use this knowledge to select appropriate time slots for serving data/content/ads. In step 170 we continuously monitor and provide feedback to the system for learning and refining a prediction model. We use the prediction model to optimize the temporal allocation of ads/content. The prediction model also serves as a monetizing tool. We can sell the model. In addition, we can also run the prediction model as a service for a subscription fee.

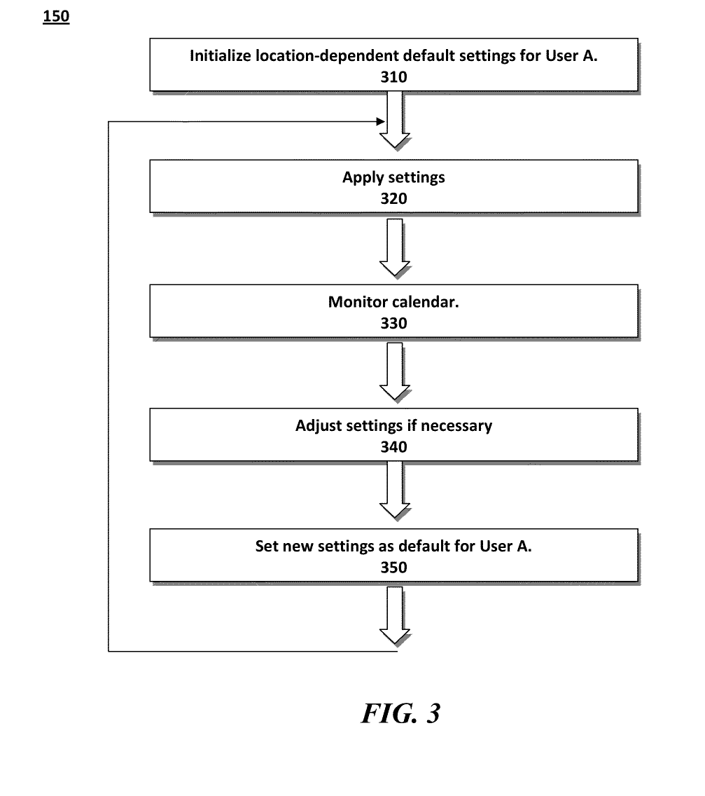

Referring now to FIG. 3 we show a lower-level flow chart of method step 150 from FIG. 1. In step 150 we eliminate the FREE time slots corresponding to periods of time when User A was unlikely to be available, such as the middle of the night and weekends. In step 310 we proceed by initializing location-dependent default settings for User A. These settings must take into consideration: time zones, cultural norms, and lifestyle/work trends; therefore they need to be constantly updated. For example, in the American Midwest, 5:00 to 6:00 p.m. is generally considered to be “close of business” but in Japan, office hours are longer, so the settings for User A in Japan would need to reflect this.

The settings are then applied in step 320. User A's calendar is monitored in step 330. Alternatively, rather than monitor the calendar, we can set to be “pinged” when a new entry is made to the calendar. According to the information gleaned from User A's schedule, we adjust the initial settings in step 340. We set these new adjusted settings as the default settings in step 350. The process loops back to step 320 where we apply the settings.

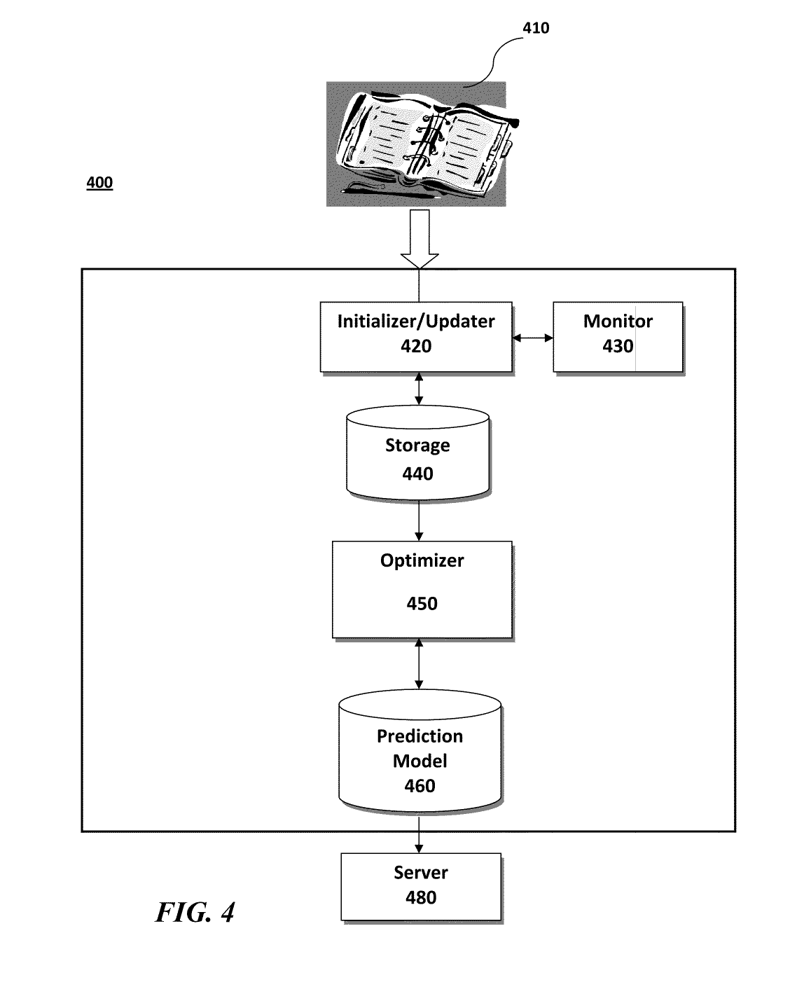

FIG. 4—System embodiment.

Referring now to FIG. 4 we show a simplified block diagram of a cross-platform targeting system 400 according to an embodiment of the present invention. The system 400 includes the following components: Initializer/Updater 420, Storage 430, Optimizer 440, and Prediction Model 450. Storage 430 can be local or remote. Those skilled in the art will appreciate that the functionality implemented within the blocks illustrated in the diagram may be implemented as separate components or the functionality of several or all of the blocks may be implemented within a single component. For example, the functionality for the Initializer/Updater 420 may be included in the same component as the Optimizer 440.

The system 400 receives as input User A's on-line calendar 410. The Initializer/Updater 420 initializes the default settings for User A and also performs updating of those settings when it is determined that the default settings need to be changed. The Monitor 430 either monitors User A's calendar 410 for new entries or receives alerts when a new entry is posted. The entries are stored in Storage 440 and then fed into the Optimizer 450 which determines the optimal time to send communication to User A for more effective results. This information is fed into the Prediction Model 450. The Prediction Model 460 provides the optimal targeting time slots for User A to an advertiser, retailer, or other server engine 480. Server 480 can be a customer subscribing to the cross-platform targeting system 400 on a subscription basis.

Benefits and advantages.

We list here some of the many benefits and advantages in implementing the method according to embodiments of the invention:

1. We maintain platform independence because we do not rely on a particular domain or calendar system. We leverage existing technology which allows calendars to share across multiple entities such as Yahoo!, Google, Outlook, and the like.

2. The user's privacy is protected because there does not need to be an intrusion into a user's events. In contrast, sites like Facebook require context such as event details.

3. Knowledge of the user's free time enables the ability to push content when it is most likely to be viewed. This reduces the amount of ineffective ads or content pushes. Click through rate (CTR), cost per action (CPA), Time Spent, etc. goes up since the user may have more time in hand now to go through the content being rendered based on this intelligent system. CTR is the rate to pay for someone clicking on an ad. CPA is the rate to pay for someone actually clicking on an ad and completing a transaction.

4. Broad usage due to the fact that the ad/content rendering can happen on the Web and mobile/mail+web page; easily extendable to mobile.

5. Because we know when to serve the ad, we increase the chances of making a sale when user is available to read the ad. Deals and coupons/discounts sent during a FREE time slot has a higher probability to be read than one which arrives during a busy or peak time of work for the user.

6. We have access to the calendar schedules; therefore we also have access to the event participants that ACCEPT and/or DECLINE to attend events. We can tap into these third party calendar slots and keep them in the radar for future targeting as well. For example, assume a scheduled meeting among a Yahoo! user, a Gmail user, and an Outlook user. All of these calendars will show as BUSY for this common meeting. We already have the email address and IP details for future communication. User reach becomes independent now, unlike Facebook Events where only Facebook users are involved in future targeting. This broadens our scope.

7. We create a way to render data across different social platforms.

8. We generate a prediction model that can be used to set trends. In due time, User A's trend can also help us gauge the time slices when this user seems to be busy. This becomes a prediction model after some time and converts the user's misses to hits more accurately.

9. We eliminate the need for a user to explicitly provide a convenient time for reading content on mails or on his/her home page.

10. Less overhead because we do not need to read mails or know any meeting context. We simply look at the user's FREE/BUSY time slots to know the optimal time to serve ads/push content, increasing Web metrics.

11. Through the prediction model, the system becomes more tuned to the user and not the other way around.

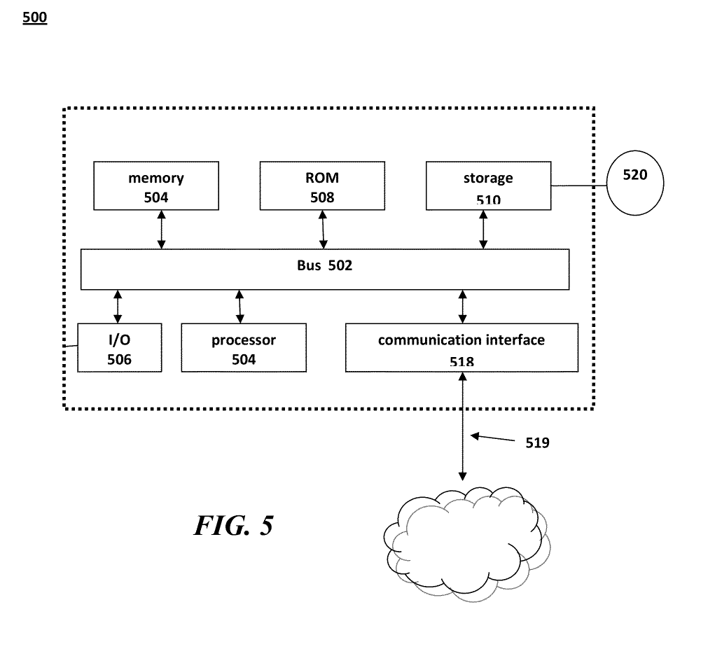

FIG. 5—Hardware Embodiment.

Referring now in to FIG. 5, there is provided a simplified pictorial illustration of an information processing system 500 for cross-platform targeting in which the present invention may be implemented. For purposes of this invention, computer system 500 may represent any type of computer, information processing system or other programmable electronic device, including a client computer, a server computer, a portable computer, an embedded controller, a personal digital assistant, a tablet computer, Internet-TV, a Cloud computing device, and so on. The computer system 500 may be a stand-alone device or networked into a larger system. Computer system 500, illustrated for exemplary purposes as a networked computing device, is in communication with other networked computing devices (not shown) via network link 519. As will be appreciated by those of ordinary skill in the art, network link 519 may be embodied using conventional networking technologies and may include one or more of the following: local area networks, wide area networks, intranets, public Internet and the like.

Computer system 500 includes processing device 502 which communicates with an input/output subsystem 506, memory 504, storage 510 and network 519. The processor device 502 is operably coupled with a communication infrastructure 522 (e.g., a communications bus, cross-over bar, or network). The processor device 502 may be a general or special purpose microprocessor operating under control of computer program instructions executed from memory 504 on program data. The processor 502 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 504 may be partitioned or otherwise mapped to reflect the boundaries of the various memory subcomponents. Memory 504 may include both volatile and persistent memory for the storage of: operational instructions for execution by CPU 502, data registers, application storage and the like. Memory 504 preferably includes a combination of random access memory (RAM), read only memory (ROM) and persistent memory such as that provided by a hard disk drive 510. The computer instructions/applications that are stored in memory 504 are executed by processor 502. The computer instructions/applications and program data can also be stored in hard disk drive 510 for execution by processor device 502.

The I/O subsystem 506 may comprise various end user interfaces such as a display, a keyboards, and a mouse. The I/O subsystem 506 may further comprise a connection to a network 519 such as a local-area network (LAN) or wide-area network (WAN) such as the Internet. The computer system 500 may also include a removable storage drive 520, representing a floppy disk drive, a magnetic tape drive, an optical disk drive, etc. The removable storage drive 520 reads from and/or writes to a removable storage unit in a manner well known to those having ordinary skill in the art. Removable storage unit can be a floppy disk, a compact disc, magnetic tape, optical disk, CD-ROM, DVD-ROM, etc. which is read by and written to by removable storage drive 520. As will be appreciated, the removable storage unit 520 includes a non-transitory computer readable medium having stored therein computer software and/or data.

The computer system 500 may also include a communications interface 518. Communications interface 518 allows software and data to be transferred between the computer system and external devices. Examples of communications interface 518 may include a modem, a network interface (such as an Ethernet card), a communications port, a PCMCIA slot and card, etc. Software and data transferred via communications interface 518 are in the form of signals which may be, for example, electronic, electromagnetic, optical, or other signals capable of being received by communications interface 518.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for cross-platform targeting, comprising:
using an input/output interface, receiving input comprising calendar entries from a calendar associated with a first user, said calendar entries designating specified time slots associated with scheduled events;
using a processor device, performing steps of:
marking the specified time slots associated with the scheduled events as unavailable;
eliminating the unavailable time slots from the calendar associated with the first user;
determining from remaining time slots, those time slots wherein the first user is deemed unlikely to be available;
removing from the remaining time slots those time slots where the first user is deemed unlikely to be available, thus providing free time slots; and
presenting the free time slots as optimal time slots for serving digital information to the first user.

2. The method of claim 1 further comprising:
receiving an indication that at least one of the scheduled events includes a second user; and
performing the steps of marking, eliminating, determining, removing, and presenting for the second user.

3. The method of claim 1 further comprising:
providing the calendar entries as input into a prediction model.

4. The method of claim 1 wherein the digital communication comprises on-line advertisements.

5. The method of claim 1 wherein the determining step comprises:
assigning location-dependent unavailable default time slots.

6. The method of claim 5 wherein the assigning step comprises:
applying parameters affecting availability, said parameters selected from a group consisting of: time zones, cultural mores, and lifestyle trends.

7. The method of claim 6 further comprising:
overriding the location-dependent unavailable default time slots.

8. The method of claim 1 further comprising:
serving the digital communication to the user during the optimal time slots.

9. An information processing system for cross-platform targeting comprising:
a processor device; and
a memory operably coupled with the processor device, said memory having stored therein computer-executable instructions comprising:
receiving input comprising calendar entries from a calendar associated with a first user, said calendar entries designating specified time slots associated with scheduled events;
marking the specified time slots associated with the scheduled events as unavailable time slots;
eliminating the unavailable time slots from the calendar associated with the first user;
determining from remaining time slots, those time slots wherein the first user is deemed unlikely to be available;
removing from the remaining time slots those time slots where the first user is deemed unlikely to be available, thus providing free time slots; and
presenting the free time slots as optimal time slots for serving digital communication to the first user.

10. The information processing system of claim 9 wherein the computer-executable instructions further comprise:
receiving an indication that at least one of the scheduled events includes a second user; and
performing the steps of marking, eliminating, identifying, determining, removing, and presenting for the second user.

11. The information processing system of claim 9 further comprising:
a prediction model receiving as input the calendar entries.

12. The information processing system of claim 9 wherein the digital communication comprises on-line advertisements.

13. The information processing system of claim 9 wherein the digital communication comprises pushed content.

14. The information processing system of claim 9 wherein the computer-executable instructions for the determining step comprise:
assigning location-dependent unavailable default time slots.

15. The information processing system of claim 14 wherein computer-executable instructions for the assigning step comprise:
applying parameters affecting availability, said parameters selected from a group consisting of: time zones, cultural mores, and lifestyle trends.

16. The information processing system of claim 15 wherein the computer-executable instructions further comprise:
overriding the location-dependent unavailable default time slots.

17. The information processing system of claim 9 wherein the computer-executable instructions further comprise:
serving the digital communication to the user during the optimal time slots.

18. A computer program product comprising a tangible computer-readable storage medium with computer-executable instructions stored therein, said computer-executable instructions comprising:
receiving input comprising calendar entries from a calendar associated with a first user, said calendar entries designating specified time slots associated with scheduled events;
marking the specified time slots associated with the scheduled events as unavailable time slots;
eliminating the unavailable time slots from the calendar associated with the first user;
determining from remaining time slots, those time slots wherein the first user is deemed unlikely to be available;
removing from the remaining time slots those time slots where the first user is deemed unlikely to be available, thus providing free time slots; and
presenting the free time slots as optimal time slots for serving digital communication to the first user.

19. The computer program product of claim 18 wherein the computer-executable instructions for the determining step comprise:
assigning location-dependent unavailable default time slots by applying parameters affecting availability, said parameters selected from a group consisting of: time zones, cultural mores, and lifestyle trends.

20. The computer program product of claim 19 wherein the computer-executable instructions further comprise:
overriding the location-dependent unavailable default time slots.
